(19) United States
(12) Patent Application Publication
(10) Pub. No.: US 2003/0146975 A1
(43) Pub. Date: Aug. 7, 2003

(54) Time variant defect correcting method and apparatus in infrared thermal imaging system

(76) Inventors: Shi-Chang Joung, Chollabuk-do (KR); Jin-Sin Ko, Suwon-shi (KR)

Correspondence Address: CHA & REITER, 411 HACKENSACK AVE, 9TH FLOOR, HACKENSACK, NJ, 07601, US

(21) Appl. No.: 10/159,472

(22) Filed: May 31, 2002

(30) Foreign Application Priority Data
Feb. 7, 2002 (KR) 2002-7107

(51) Int. Cl. H04N 5/33

(52) U.S. Cl. 348/164

(57) ABSTRACT

There is provided a time variant defect correcting method in an infrared thermal imaging system. Digital video signals representing a frame are received and it is determined whether a first pixel from the frame is likely to be a defect. If the first pixel is likely to be a defect, the number of defect determinations for the first pixel is counted and the count value is compared with a threshold count. If the count value is equal to or less than the threshold count, digital video signals representing a next frame are received and it is determined whether the first pixel in the next frame is likely to be a defect. If the count value exceeds the threshold count, the first pixel is registered as a defect and corrected.

### CLAIM OF PRIORITY

This application makes reference to and claims all benefits accruing under 35 U.S.C. Section 119 from an application entitled “Time Variant Defect Correcting Method and Apparatus in Infrared Thermal Imaging system” filed in the Korean Industrial Property Office on Feb. 7, 2002 and there duly assigned Serial No. 2002-7107.

### BACKGROUND OF THE INVENTION

1. Field of the Invention

The present invention relates generally to an infrared thermal imaging system, and in particular, to a method and apparatus for correcting a time variant defect by comparing correlations between pixels in an infrared detector.

2. Description of the Related Art

An infrared thermal imaging system senses a slight difference in infrared energy emitted from an object through an infrared camera, converts the difference to an electrical signal, and represents it as an image. The infrared energy difference increases in proportion to temperature difference in the object. This means that objects different in temperature can be represented as thermal images. Infrared thermal imaging systems are widely used in industrial applications such as heat loss detection in buildings, measuring the total mass inside a storage tank, defect detection in transmission lines, and security monitoring. Infrared thermal imaging systems may also be used to inspection and analyze Printed Circuit Boards (PCBs), in satellite-based weather forecasting, and in medical devices.

In a conventional infrared thermal imaging system, an infrared detector is used to convert infrared energy differences monitored by an infrared camera to voltage components at every frame period. Voltage components are output as analog infrared video signals. In general, the infrared detector exhibits non-uniform spatial output characteristics and produces a slightly different output at each pixel even if the same temperature difference is monitored. In addition, the infrared detector may not produce an output or may produce an unstable output for some pixels. Due to these image quality deteriorations, the infrared thermal imaging system needs to correct the infrared video signals through various signal processing methods.

Two conventional methods can be adopted to improve image quality in the infrared thermal imaging system according to time points of correction and correction continuity. The first method is to initially correct defects once using a non-linearity correction procedure.. The second method is to calculate gain and offset variations for all pixels and update previous gain and offset values in the infrared detector.

According to the first image quality improving method, the non-linearity of a pixel is calculated using video signals acquired from a uniformly high temperature object (i.e., a high temperature reference source) and a uniformly low temperature object (i.e., a low temperature reference source). FIG. 1 is a graph showing output characteristics of the infrared detector at each pixel. As illustrated in FIG. 1, the infrared detector has a gentle temperature-output characteristic curve at each pixel. The temperature-output characteristic curve can be simplified to a line by connecting an output at the average temperature of the low temperature reference source to an output at the average temperature of the high temperature reference source. The slope and the y-intercept of the line are the gain and offset of the pixel, respectively. Therefore, the non-linearity of each frame can be corrected by multiplying the gains of the pixels in the frame by their display levels and then adding their offsets to the product.

A pixel having a very slight difference between the display levels at high temperature and low temperature or a pixel exhibiting a high display level at low temperature and a low display level at high temperature is defined as a defect. The defect is corrected only once at the initial non-linearity correction by using a particular defect correction algorithm because it is not removed by the above non-linearity correction. However, the infrared detector's output characteristics may vary in time and as a result, pixels that are not determined to be defects at the initial non-linearity correction may turn out to be defects as time passes. Those defects are called time variant defects. To correct for the time variant defects, new high temperature and low temperature reference sources should be used and the gain and offset should be updated.

The second image quality improving method is to update gain and offset by calculating the gain and offset of each frame to take into account that the output characteristics of the infrared detector may vary with time. Although the time variant defects can be corrected to some extent using this method, the gain and offset updating at each frame requires a great deal of computation. This makes practical implementation difficult and can cause a blurring phenomenon for a still image.

### SUMMARY OF THE INVENTION

The present invention is related to a method and apparatus for correcting time variant defects in an infrared detector.

According to one aspect of the invention, a method and apparatus of correcting time variant defects by comparing correlations between pixels in an infrared detector are provided.

The foregoing aspects of the present invention are achieved by providing a time variant defect correcting method in an infrared thermal imaging system. According to one aspect of the present invention, in a time variant defect correcting method, digital video signals representing a frame are received and it is determined whether a first pixel from the frame is likely to be a defect. If the first pixel is likely to be a defect, the number of defect determinations for the first pixel is counted and the count value is compared with a threshold count. If the count value is equal to or less than the threshold count, digital video signals representing a next frame are received and it is determined whether the first pixel in the next frame is likely to be a defect. If the count value exceeds the threshold count, the first pixel is registered as a defect and corrected.

According to another aspect of the present invention, in a time variant defect correcting method, digital video signals representing a frame are received and the edge values of a first pixel in the frame are calculated with respect to at least two of pixels adjacent to the first pixel. If the edge values exceed a threshold edge value, the average display level of the adjacent pixels is calculated, and the difference between the calculated average display level and the average display level of the adjacent pixels in a previous frame is calculated. If the difference exceeds a threshold average difference, the number of defect determinations made for the first pixel is counted. If the count value is equal to or less than a threshold count, digital video signals representing a next frame are received and the edge values of the first pixel in the next frame are calculated with respect to at least two of pixels adjacent the first pixel. If the count value exceeds the threshold count, the first pixel is registered as a defect and corrected.

According to a further object of the present invention, in a time variant defect correcting apparatus, a first memory receives digital video signals representing a frame at every frame period. An image processor determines whether a first pixel from the frame is likely to be a defect, counts the number of defect determinations for the first pixel if the first pixel is likely to be a defect, compares the count value with a threshold count, receives digital video signals representing a next frame and determines whether the first pixel in the next frame is likely to be a defect, if the count value is equal to or less than the count threshold, and registers the first pixel as a defect and corrects the defect, if the count value exceeds the threshold count. A second memory stores the location of the first pixel registered as a defect.

### BRIEF DESCRIPTION OF THE DRAWINGS

The above and other features and advantages of the present invention will become more apparent from the following detailed description when taken in conjunction with the accompanying drawings in which:

FIG. 1 is a graph showing an output characteristic at each pixel in an infrared detector;

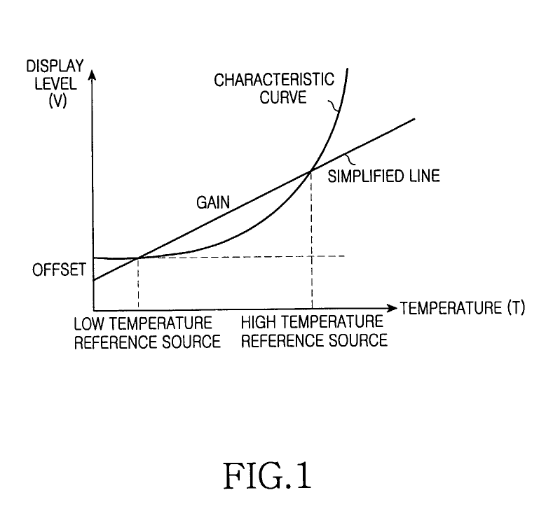

FIG. 2 is a block diagram of an infrared thermal imaging system to which the present invention is applied;

FIG. 3 is a flowchart illustrating a time variant defect correcting operation according to an embodiment of the present invention;

FIG. 4 illustrates a pixel detected from a frame memory and its adjacent pixels; and,

FIG. 5 illustrates correction of pixels registered as defects.

### DETAILED DESCRIPTION OF THE PREFERRED EMBODIMENT

A preferred embodiment of the present invention will be described below with reference to the accompanying drawings. In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. In the following description, well-known functions or constructions are not described in detail since they would obscure the invention in unnecessary detail.

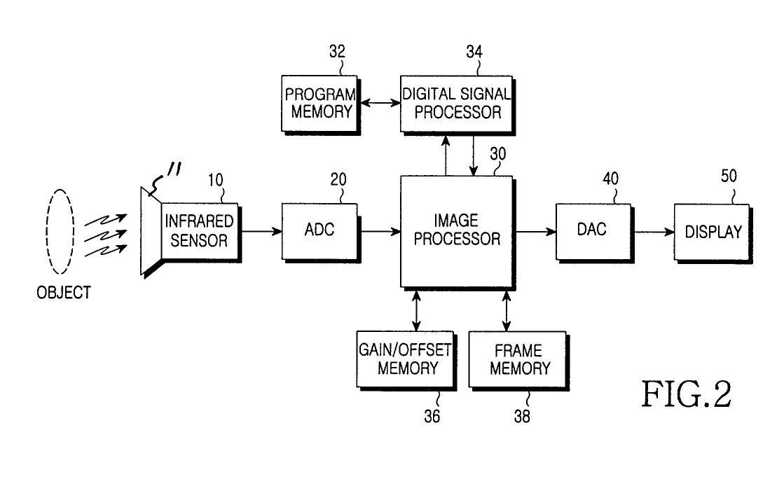

FIG. 2 is a block diagram of an infrared thermal imaging system to which one embodiment of the present invention is applied. Referring to FIG. 2, an infrared sensor 10 senses infrared light emitted from an object by means of an infrared camera 11 and outputs infrared video signals representing the display levels of pixels according to a predetermined resolution of the infrared camera 11. The infrared video signals are converted to digital video signals each having a predetermined number of bits at each frame period in an analog-to-digital converter (ADC) 29.

An image processor 30 performs predetermined signal processing necessary to display the digital video signals as an image. The image processor 30 may represent, e.g., a microprocessor, a central processing unit, a computer, a circuit card or an application-specific integrated circuit (ASICs) and may also include a digital signal processor 34. A digital-to-analog converter (DAC) 40 converts the processed digital video signals to analog video signals and feeds them to a display 50 to be displayed as an image.

Various functional operations associated with the infrared imaging system 10 may be implemented in whole or in part in one or more software programs/signal processing routines stored in a program memory 32 and executed by the image processor 30. The program memory 32 may represent, e.g., disk-based optical or magnetic storage units, electronic memories, as well as portions or combinations of these and other memory devices. In other embodiments, however, hardware circuitry may be used in place of, or in combination with, software instructions to implement the invention.

Regarding the predetermined signal processing, the image processor 30 calculates the gain and offset of each pixel. The gains and offsets are stored in the form of a list in a gain/offset memory 36. A frame memory 38 stores the digital video signals received from the ADC 20 on a frame basis and then provide the stored digital video signals to the image processor 30. The image processor 30 determines whether there are defective pixels (i.e., defects) in the frame while the infrared thermal imaging system is operative and registers the locations or addresses of defective pixels in the gain/offset memory 36.

More specifically, the image processor 30 reads digital video signals on a frame basis from the frame memory 38 and processes the digital video signals by non-linearity correction and a defect correction, if necessary. The display levels of normal pixels are multiplied by their gains and added to their offsets, for non-linearity correction, while defective pixels can be corrected by defect correction methods described in detail below.

To better understand the teachings of the present invention, the principle of time variant defect detection will be described below.

In an infrared thermal imaging system, a defect is expressed as an isolated point having an almost constant display level regardless of a temperature change in an object. This defect usually has edge components in every direction when compared to eight pixels adjacent to the defective pixel in vertical, horizontal, and diagonal directions. Even if the adjacent pixels vary in display level, the display level of the defective pixel is maintained at the same level. Here, an edge component refers to the difference between the display levels of the defective pixel and its adjacent pixel. If a pixel has some or whole edge values greater than a predetermined threshold edge value, it can be said that the pixel is likely to be a defect.

In the case of a slow moving picture, a normal pixel may be considered a defect in the above method because an object expressed as a point can maintain the same pixel location in successive frames. To avoid such a situation, a pixel is finally determined to be a defect if the pixel has edge values greater than the threshold edge value in a predetermined number of successive frames even though its adjacent pixels change in display level.

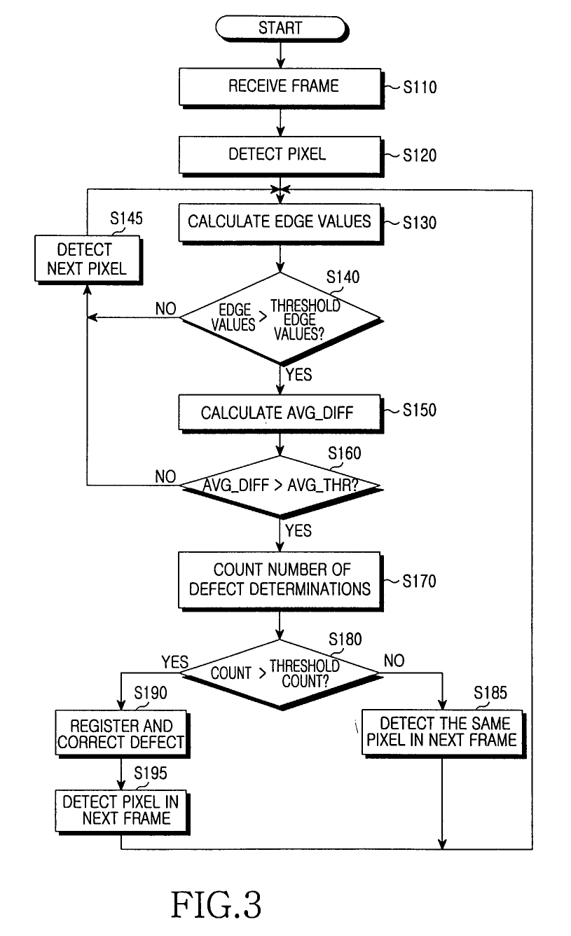

FIG. 3 is a flowchart illustrating a time variant defect correction operation according to an embodiment of the present invention. Referring to FIG. 3, digital video signals received from the ADC 20 are stored on a frame basis in the frame memory 38 in step S110. To detect a time variant defect, the image processor 30 reads a first pixel from the whole current frame or a predetermined area of the current frame in step S120 and calculates the edge values of the first pixel with respect to its adjacent pixels in step S130.

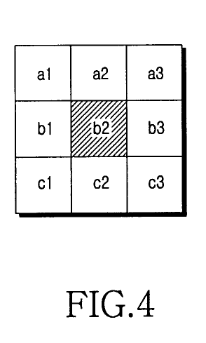

FIG. 4 illustrates a pixel read from the frame memory 38 and its adjacent pixels. Referring to FIG. 4, a pixel b2 is adjacent to pixels a2 and c2 in a vertical direction, to pixels b1 and b3 in a horizontal direction, and to pixels a1, c3, a3 and c1 in a diagonal direction. Suppose that the reference characters a1 to c3 also denote the display levels of the corresponding pixels. Then, the vertical, horizontal, and diagonal edge values of the pixel b2 are respectively |2×b2−(a2+c2)|, |2×b2−(b1+b3)|, and |2×b2−(a1+c3)| & |2×b2−(a3+c1)|.

The edge values are compared with a predetermined threshold edge value in step S140. If all the edge values exceed the threshold edge value, it is determined that the pixel is likely to be a defect. This can be expressed as

|2×b2−(a2+c2)|>EDGE_THR

|2×b2−(b1+b3)|>EDGE_THR

|2×b2−(a1+c3)|>EDGE_THR

|2×b2−(a3+c1)|>EDGE_THR (1)

where a1 to c3 are the display levels of the first pixel and its adjacent pixels and EDGE_THR is the threshold edge value.

It is noted however that a pixel may be considered likely to be a defect if at least two of its edge values exceeds the threshold edge value.

If at least one of the edge values is equal to or less than the threshold edge value, it is determined that the pixel is a normal one. Then, the image processor 30 takes a second pixel from the current frame in step S145 and repeats the defect detection procedure in steps S130 and S140.

For the pixel determined likely to be a defect (e.g., if all the edge values exceed the threshold edge value) the image processor 30 calculates the average display level of the adjacent pixels and the difference between the current average display level and the average display value of the pixels at the same locations in the previous frame in step S150. The average display level difference AVG_DIFF is calculated by

$$AVG\_DIFF = \frac{( a1 + a2 + a3 + b1 + b3 + c1 + c2 + c3 )}{8} - \frac{( {a1}^{′} + {a2}^{′} + {a3}^{′} + {b1}^{′} + {b3}^{′} + {c1}^{′} + {c2}^{′} + {c3}^{′} )}{8} \qquad ( 2 )$$

where a1, a2, a3, b1, b3, c1, c2 and to c3 denote the display levels of the adjacent pixels in the current frame and a1′, a2′, a3′, b1′, b3′, c1′, c2′ and to c3′ denote the display levels of the pixels at the same locations in the previous frame. The current average display level calculated in step S150 is stored for use in next defect detection.

The average display level difference is compared with a threshold average difference in step S160. The threshold average difference is empirically obtained or set to an arbitrary value. If the time variant defect detection is performed before the infrared thermal imaging system comes out to the market, i.e., during a factory set-up, the threshold average difference is set to a relatively low value within a range of 10 and 100 (if the display level is indicated in 10 bit (0-1023)),and a thermal image is input from a reference source having a uniform temperature as a whole. It is noted that in the case of a relatively active thermal image, the threshold average difference should be set higher than in the case of a relatively stationary thermal image. In the case of a relatively stationary thermal image, the threshold average difference is set lower to increase defect detection accuracy.

If the average display level difference is equal to or less than the threshold average difference in step S160, it is determined that the pixel is a normal one. Then, the image processor 30 takes the second pixel from the current frame in step S145 and repeats the defect determination procedure in steps S130 to S160.

On the other hand, if the average display level exceeds the threshold average difference in step S160, the image processor 30 registers the pixel as a pseudo-defect and increases a count indicative of the number of defect detections for the pixel by one in step S170. Registration of the pixel as a pseudo-defect means that the pixel location is not actually stored in the gain/offset memory 36 but the number of defect detections for the pixel is counted.

The count is compared with a threshold count CNT_THR in step S180. If the count is less than the threshold count, the image processor 30 receives digital video signals representing the next frame and detects the pixel in the same location in step S185 and repeats the steps S120 to S180 in order to more accurately determine whether the pixel is also likely to be a defect.

If the count is equal to the threshold count, the image processor 30 determines that the pixel is a defect and registers the pixel as a defect in the gain/offset memory 36 and corrects the defect by the defect correction method in step S190. Then, the image processor 30 clears the count, receives the digital video signals of the next frame, and takes the second pixel from the next frame in step S195, and then repeats steps S120 to S190.

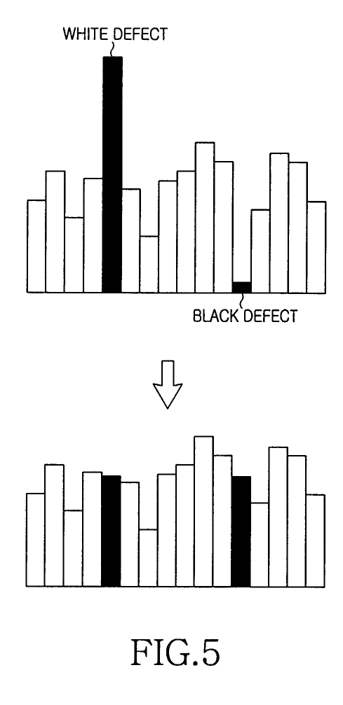

There are many ways to correct the defect in step S190. For example, a pixel registered as a defect is corrected by replacing its display level with the display level of one of its adjacent pixels. In the case of a single defect, the defect is corrected by replacing its display level with the average display level of the adjacent pixels, as illustrated in FIG. 5.

Referring to FIG. 5, a pixel having a display level much higher than its adjacent pixels is called a white defect, while a pixel having a display level much lower than its adjacent pixels is called a black defect. If an n^{th} pixel is registered as a white defect or a back defect, the n^{th} pixel is corrected by replacing its display level x[n] with the average display level (x[n−1]×x[n+1]/2) of its horizontal adjacent pixels. Here, x[n−1] and x[n+1] are the display levels of the horizontal adjacent pixels.

In accordance with the embodiments of the present invention as described above, time variant defects are effectively detected and corrected in an infrared thermal imaging system, thereby improving image quality and system performance. Furthermore, logic implementation is easy and hardware size is reduced. As a result, the infrared thermal imaging system can be implemented in a small size with high performance and low cost.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A time variant defect correcting method for an infrared thermal imaging system, comprising the steps of:
(1) receiving digital video signals representing a frame;
(2) determining whether a first pixel from the frame is likely to be a defect;
(3) counting the number of defect determinations for the first pixel if the first pixel is likely to be a defect;
(4) comparing the count value with a threshold count;
(5) receiving digital video signals representing a next frame and determining whether a next pixel in a position corresponding to the first pixel in the next frame is likely to be a defect, if the count value is equal to or less than the threshold count; and
(6) defect correcting the first pixel if the count value exceeds the threshold count.

2. The time variant defect correcting method of claim 1, wherein the step of (2) comprises the steps of:
calculating a plurality of edge values of the first pixel with respect to at least two of pixels adjacent to the first pixel; and
determining that the first pixel is likely to be a defect if each of the plurality of edge values exceeds a threshold edge value.

3. The time variant defect correcting method of claim 1, wherein the step of (2) comprises the steps of:
calculating a plurality of edge values of the first pixel with respect to at least two of pixels adjacent to the first pixel;
calculating the average display level of the adjacent pixels if each of the edge values exceeds a threshold edge value;
calculating the difference between the calculated average display level and the average display level of the adjacent pixels in a previous frame; and
determining that the first pixel is likely to be a defect if the difference exceeds a predetermined threshold average difference.

4. The time variant defect correcting method of claim 2, wherein the plurality of edge values of the first pixel with respect to the at least two adjacent pixels are calculated by |2×A−(B+C)| where A is the display level of the first pixel and B and C are the display levels of pixels adjacent to the first pixel in a vertical, horizontal, or diagonal direction.

5. The time variant defect correcting method of claim 3, wherein the plurality of edge values of the first pixel with respect to the at least two adjacent pixels are calculated by |2×A−(B+C)| where A is the display level of the first pixel and B and C are the display levels of pixels adjacent to the first pixel in a vertical, horizontal, or diagonal direction.

6. The time variant defect correcting method of claim 3, wherein the threshold average difference is set according to a temperature uniformness and motion degree of an input thermal image by a manufacturer or a user.

7. The time variant defect correcting method of claim 1, further comprising the step of determining whether a second pixel in the frame is likely to be a defect, if the first pixel is not likely to be a defect in the step of (2).

8. The time variant defect correcting method of claim 1, wherein the defect correcting is performed by replacing a display level of the first pixel with an average display level of the adjacent pixels.

9. The time variant defect correcting method of claim 1, wherein the defect correcting is performed by replacing a display level of the first pixel with an display level of one of the adjacent pixels.

10. A time variant defect correcting method in an infrared thermal imaging system, comprising the steps of:
receiving digital video signals representing a frame;
calculating edge values of a first pixel in the frame with respect to at least two of pixels adjacent to the first pixel;
counting the number of defect determinations made for the first pixel if the edge values exceed a threshold edge value;
receiving digital video signals representing a next frame and calculating the edge values of a next pixel that has a position corresponding to the first pixel in the next frame with respect to at least two of pixels adjacent to the pixel, if the count value is equal to or less than a threshold count; and
registering the first pixel as a defect and correcting the defect, if the count value exceeds the threshold count.

11. A time variant defect correcting method in an infrared thermal imaging system, comprising the steps of:
receiving digital video signals representing a frame;
calculating edge values of a first pixel in the frame with respect to at least two of pixels adjacent to the first pixel;
calculating an average display level of the adjacent pixels if the edge values exceed a threshold edge value;
calculating the difference between the calculated average display level and the average display level of the adjacent pixels in a previous frame;
counting the number of defect determinations made for the first pixel if the difference exceeds a threshold average difference;
receiving digital video signals representing a next frame and calculating the edge values of the first pixel in the next frame with respect to at least two of pixels adjacent the first pixel, if the count value is equal to or less than a threshold count; and
registering the first pixel as a defect and correcting the defect, if the count value exceeds the threshold count.

12. A time variant defect correcting apparatus in an infrared thermal imaging system, comprising:
a first memory for receiving digital video signals representing a frame at every frame period;
an image processor for determining whether a first pixel from the frame is likely to be a defect, counting a number of defect determinations for the first pixel if the first pixel is likely to be a defect, comparing the count value with a threshold count, receiving digital video signals representing a next frame and determining whether a next pixel that has a position corresponding to the first pixel in the next frame is likely to be a defect, if the count value is equal to or less than the count threshold, and registering the first pixel as a defect and correcting the defect, if the count value exceeds the threshold count; and
a second memory for storing the location of the first pixel registered as a defect.

13. The time variant defect correcting apparatus of claim 12, wherein the image processor calculates the edge values of the first pixel with respect to at least two of pixels adjacent to the first pixel, and determines that the first pixel is likely to be a defect if the edge values exceed a threshold edge value.

14. The time variant defect correcting apparatus of claim 12, wherein the image processor calculates the edge values of the first pixel with respect to at least two of pixels adjacent to the first pixel, calculates the average display level of the adjacent pixels if the edge values exceed a threshold edge value, calculates the difference between the calculated average display level and the average display level of the adjacent pixels in a previous frame, and determines that the first pixel is likely to be a defect if the difference exceeds a predetermined threshold average difference.

15. The time variant defect correcting apparatus of claim 14, wherein the threshold average difference is set according to a temperature uniformness and motion degree of an input thermal image by a manufacturer or a user.

16. The time variant defect correcting apparatus of claim 12, wherein the image processor corrects the defect by replacing a display level of the first pixel registered as a defect with an average display level of the adjacent pixels.

17. The time variant defect correcting apparatus of claim 12, wherein the image processor corrects the defect by replacing a display level of the first pixel registered as a defect with a display level of one of the adjacent pixels.

18. A memory medium including code for correcting time variant defects, the code when executed causes an infrared thermal imaging system to perform steps comprising;
(1) receiving digital video signals representing a frame;
(2) determining whether a first pixel from the frame is likely to be a defect;
(3) counting the number of defect determinations for the first pixel if the first pixel is likely to be a defect;
(4) comparing the count value with a threshold count;
(5) receiving digital video signals representing a next frame and determining whether a next pixel in a position corresponding to the first pixel in the next frame is likely to be a defect, if the count value is equal to or less than the threshold count; and
(6) defect correcting the first pixel if the count value exceeds the threshold count.

19. The memory medium of claim 18, wherein the step of (2) comprises the steps of:
calculating a plurality of edge values of the first pixel with respect to at least two of pixels adjacent to the first pixel; and
determining that the first pixel is likely to be a defect if each of the plurality of edge values exceeds a threshold edge value.

20. The memory medium of claim 19, wherein the step of (2) comprises the steps of:
calculating a plurality of edge values of the first pixel with respect to at least two of pixels adjacent to the first pixel;
calculating the average display level of the adjacent pixels if each of the edge values exceeds a threshold edge value;
calculating the difference between the calculated average display level and the average display level of the adjacent pixels in a previous frame; and
determining that the first pixel is likely to be a defect if the difference exceeds a predetermined threshold average difference.
